(19) United States
(12) Patent Application Publication
(10) Pub. No.: US 2014/0202857 A1
(43) Pub. Date: Jul. 24, 2014

(54) DEVICE AND SINGLE-MOLECULE ANALYSIS METHOD BY MEANS OF DETECTION OF THE COLLISIONS OF A TARGET MOLECULE ON FUNCTIONALIZED NANOPORES

(71) Applicant: UNIVERSITA DEGLI STUDI DI GENOVA, Genova (IT)

(72) Inventors: Ugo Valbusa, Genova (IT); Luca Repetto, Genova (IT); Giuseppe Firpo, Genova (IT); Valentina Mussi, Genova (IT); Paola Fanzio, Genova (IT); Chiara Manneschi, Genova (IT); Gian Paolo Tonini, Genova (IT); Paola Scaruffi, Genova (IT); Sara Stigliani, Genova (IT); Michele Menotta, Urbino (IT); Mauro Magnani, Urbino (IT)

(73) Assignee: Universita Degli Studi Di Genova, Genova (IT)

(21) Appl. No.: 14/119,670

(22) PCT Filed: May 23, 2012
(86) PCT No.: PCT/IT2012/000150

§ 371 Date: Feb. 24, 2014

(30) Foreign Application Priority Data
May 23, 2011 (IT) RM2011A000252

(51) Int. Cl. G01N 27/447

(52) U.S. Cl. CPC G01N 27/4473
USPC 204/451; 204/601

(57) ABSTRACT

The present invention concerns a device and a method of single-molecule analysis by detection of a target molecule on functionalized nanopores in such a way that it interacts with the target molecule and has an effective diameter smaller than the dimension of the target molecule.

The present invention concerns a device and single-molecule analysis method by means of detection of the collisions of a target molecule on functionalized nanopores.

In particular, the invention concerns a single-molecule analysis method by detection of the collisions of a target molecule on nanopores, which are functionalized in such a way to interact with the target molecule and to have an effective diameter smaller than the target molecule.

The single-molecule sensing by nanopores is a fast and continuously extending field which promises to have revolutionary effects on bioanalytics and diagnostics. The first papers in this field date back to 1996 [1] and are dedicated to illustrate the properties on the proteic nanopores. Since then, much has been made at the research level to realize devices having increasing complexity and product engineering level, which are dedicated to the analysis of specific bio-molecular features or interactions. To date, the field of the possible applications of the nanopores devices is very wide, thanks also to the introduction of solid-state systems with obvious advantages of stability, modifiability and integrability with respect to biologic systems. In most cases, it deals with devices based on the measurement of the ionic current during electrophoretic translocation of the molecules through the nanopores, i.e. on an enough simple functioning principle, which does not require any procedure for labeling the molecules under examination or for optical detection. In this sense, nanopores systems represent a valid, low cost and fast alternative, with respect to the standard techniques for the analysis and the DNA sequencing.

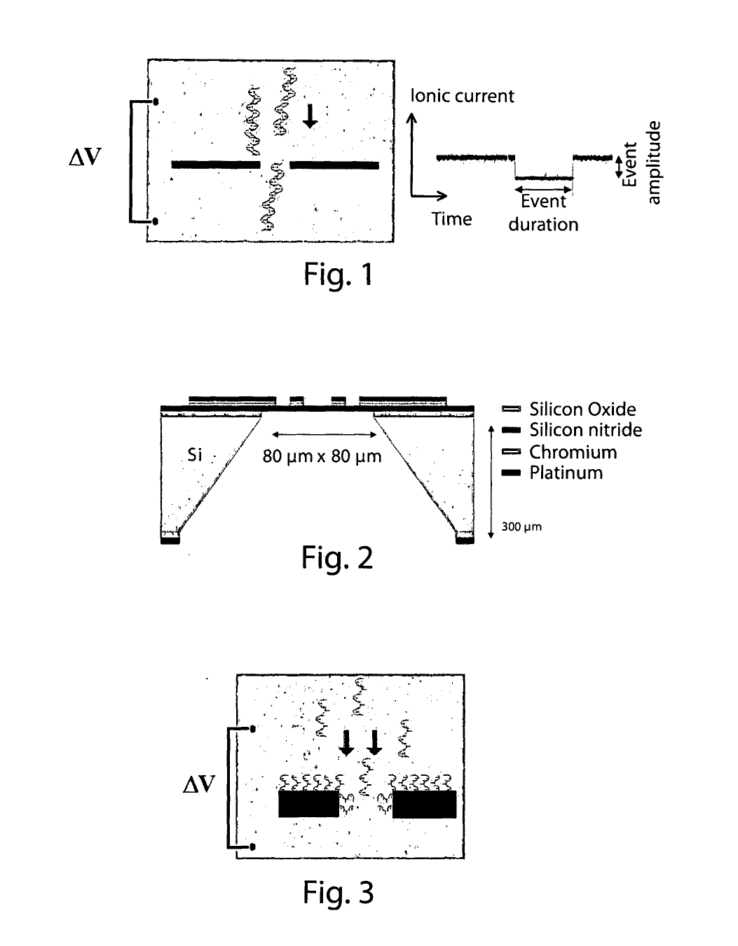

The specific mechanism of measurement of the nanopores devices unifies the sieving of the molecules and the measurement of a ionic current of single channel: the conductance of the nanopore separating two tanks containing ionic solution is modulated by the passage of the single molecules which cause a physical or electrostatic occupation of the nanopore. This temporary obstruction of the hole, with relevant temporary decreasing of the detected current, provides information on the dimensions of the analyzed molecule or the specific interaction between molecule and nanopore (FIG. 1).

The properties of the nanopore can be altered by introducing specific artificial sites of bond or recognition, by means of processes of modification of the surface chemical properties. In this way, it is possible to make the devices selective and to introduce new biologic and chemical functionalities. For example, the proteic holes have been engineered by means of substitutions of the constitutive amino-acids to detect metallic ions, or by means of the covalent adhesion of oligo-nucleotides for analyzing complementary single-filament DNA target molecules [2], or by means of the adhesion of PEG chains to study the proteins [3].

A similar approach has been recently applied to the solid-state nanopores which, as above said, are more robust and stable then the biologic ones, but substantially chemically inert and non-selective. For example, the spontaneous absorption of thiols on gold and silver surfaces has been exploited to alter the surface charge of nanopores covered by metallic films and permanently attack various biochemical species along the channel walls [4], whilst nanopores realized on oxide membranes have undergone silanization processes [5,6] constituting the first passage of activation to obtain the functionalization with amino-modified molecules. In a similar way, the nanopores realized using polymeric material are activated by means of the formation of carboxylic groups constituting the bridge structure for the adhesion of the biomolecules.

The modification of the chemical properties has also the function of adjusting or removing undesired properties: in [7] the authors depose a aluminum oxide layer on nanopores of silicon nitride (SiN) for reducing the low-frequency electric noise and the selectivity to cations, whilst in [8] Wanunu and Meller demonstrate the possibility of controlling the device response to the modifications of the pH thanks to the deposition of a auto-assembled layer of organosilanes. Alternatively, Nilsson et al. [5] have succeeded in the functionalization of a nanopore of SiN by modifying only locally its surface thanks to the controlled deposition of a oxide ring just at the entrance of the hole. The ring can, indeed, undergo to a silanization to be able to bind single-filament DNA molecules that can be used for the hybridization processes analysis.

Engineered devices of such a type, both biological and [symbol] artificial [symbol] , exactly constitute the basis of a new class of biosensors that can be used for example for the detection of the gene expression profile: a measurement of ionic current through the functionalized nanopore allow to analyze the translocations of the single molecules, distinguishing the events of simple passage from those of semi-stable interaction (between complementary target molecules and probe molecules bound to the hole's entrance). In such a way, it is even possible to identify the presence of single-base mismatch between two filaments of probe and target DNA. Such a type of detection is however always based on the analysis of the duration and frequency of the translocation events. It can therefore be very sensitive and fast, but it must be adjusted in a correct way with respect to the specific analyzed interaction and the dimensions of the molecules under examination.

Very briefly one can say that the problem correlated to the functionalized nanopore devices for the single molecule analysis remains that of the dimensions in play. The proteic holes of alpha-emolysin studied so far have a fixed dimension of around 2 nm, which allows the passage of DNA single-strand molecules DNA and not DNA double-strand molecules; while the solid-state holes, realized by various techniques (Ion sculpting, Focused Ion Beam, Transmission Electron Microscope, track etching) on suspended thin membranes, must have initial dimensions such that, once functionalized with the probe molecules, they come out to be of dimensions (diameter) comparable with those of the target molecules, so as to allow the passage, and be however sensitive to their volume occupation. Some authors have proposed to use ionic or electronic scanning beams to adjust the diameter of the holes, or to study holes permanent obstruction events (in the case of the analysis of the interaction between the probe molecules bound to the hole and the target molecules that are larger than the nanopore and are present in the solution) [9], or to analyze the changes of the electric properties of the holes caused by the permanent adhesion of the molecules to the surface of the pore channel (for example the modification of the electric noise level [10] or rectification of the I/V curve [11]). In all the cases, it deals with solutions of difficult realizations that make the device preparation procedure complex (for example the scanning with ionic and electronic beams) or make the analysis of the results critical on the basis of the detection of events of difficult attribution (as the permanent occlusion).

The experiment of translocation suffers, moreover, of a problem connected to the low occurrence rate of the detectable events. In other words, the capture efficiency of the hole remains limited and further diminishes in the case the nanopore has an additional surface charge due to the chemical functionalization. Some authors have proposed to alter the equilibrium between the salt concentration in the two reservoirs to exploit of “electrostatic focusing” able to increment the number of molecules pushed at the hole's entrance [12], but the problem keep today unsolved for the functionalized holes. In many cases the two problems, the dimensional one and the one associated to the capture efficiency, are connected and intermingled: proteins or molecules, that are too large to be able to pass through the nanopore, arrive on the membrane surface and are pushed back, i.e. they undergo a collision process with the nanopore that is often indicated as “bumping” and identified as “unfavorable event” [13]. Generally one believes that these events do not carry information on the system under study. By the words of authors of [13]: “( . . . ) numerous fast blockades were independent of polymer length ( . . . ) or applied potential. We attribute these fast peak blockades to polymers that collided with the channel, or partially entered but failed to traverse the channel.”.

The problem comes out to be particularly relevant in the case of the sensing of proteins, which, once arrived at the entrance of the hole, must undergo a further process of unfolding in order to translocation. In this last case, the collisions come out to be experimentally associated to events of temporary blocking of the current which have the same magnitude of the translocations. The two types of events are therefore difficult to be distinguished and separated from each other. This obliges to a complex analysis of the data whose examination is required by the dependency of the events duration from the applied voltage, the length of the molecules under examination, or the external parameters such as the temperature or the pH. On the other hand, the bumping events can, exactly for this reason, be utilized to draw important information therefrom, for example on the binding status between the target molecules in the input reservoir [14] or on the dependency of the proteins unfolding degree from the boundary conditions [15].

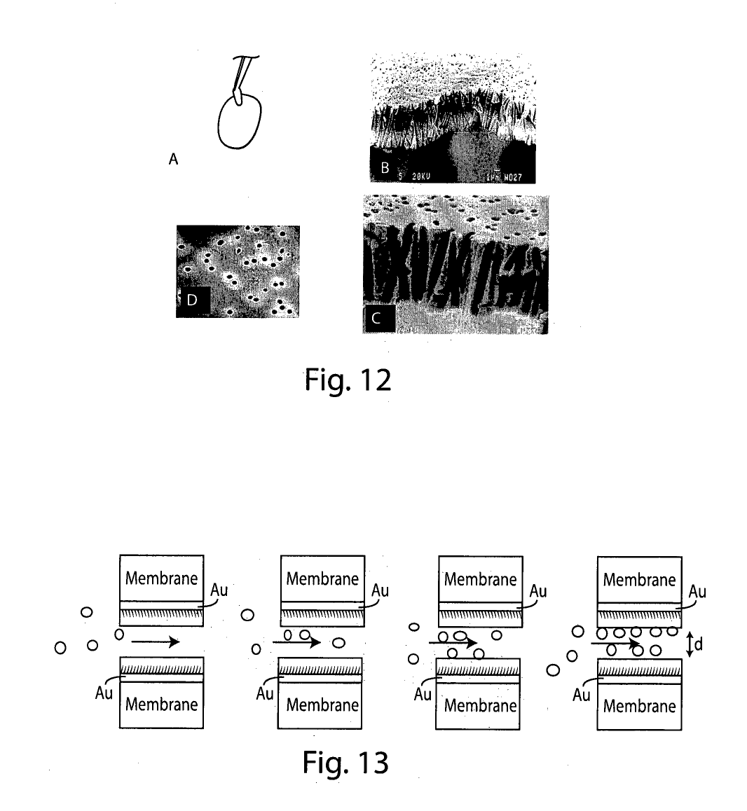

The device of Singh [16] for the detection of a specific protein (Ara h1) at low concentration is based on the use of a nanopore polymeric membrane. It deals with a commercial object which has the visible appearance of FIG. 12A. Essentially, it is a thick film (no less than 6 micron, see paper of Singh, page 101, statement under formula no. 7) which contains many holes produced by irradiation with high-energy ions. FIGS. 12B and 12C herein give two subsequent magnifications of a membrane cut to show the surface filled of holes, and the lower through channels, whilst FIG. 12D is an image of the surface.

The authors coat the channels walls with a gold layer and then with a molecules layer constituted by an antibody (i.e. by a molecule able to selectively bind itself to the protein under examination). It deals with an actual coating. Obviously, both the gold layer and the one constituted by the molecules have their thickness, so that the channels of the membrane, those that are visible in FIG. 12C, are consequently uniformly obstructed. If we imagine to transversally cut one of the channels, it comes out a structure of the type of one of the images of FIG. 13.

Thereafter, the authors set the membrane up so as to separate two reservoirs containing ionic solution, apply a voltage and measure a current. The device will be therefore characterized by a certain impedance Z given by the ratio between the applied voltage and the detected current. The impedance depends on the transversal dimensions of the channel of FIG. 1, i.e. on the diameter of the free portion, d. In particular, the authors of [16] test 3 different devices, all made in the same way as above described, but starting from membranes whose holes have a different initial diameter: 15 nm, 30 nm, 50 nm.

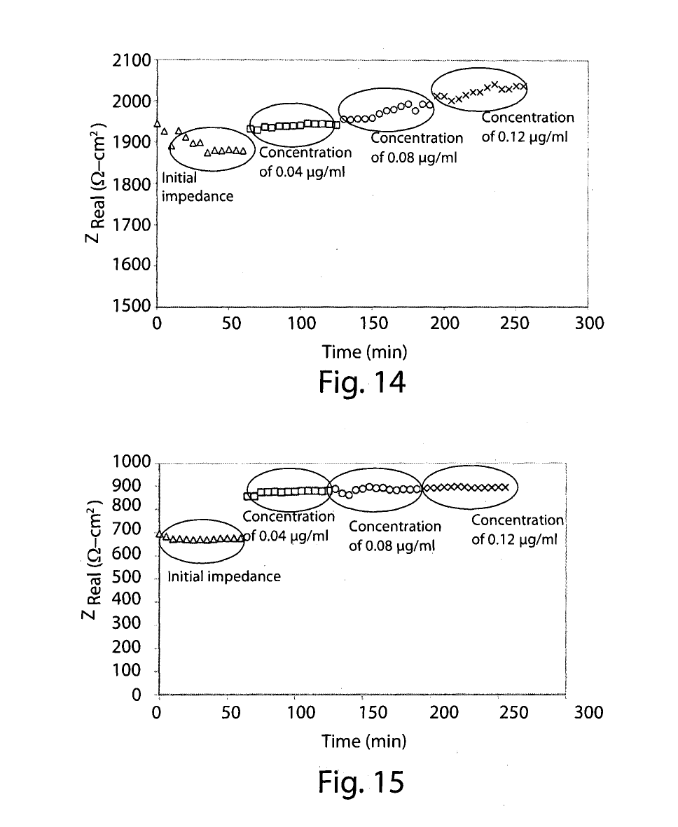

At this point the authors make the proteins pass through these channels, always applying a voltage difference. The proteins, highlighted in blue in FIG. 13, start passing into the channel. With the progressive diffusion of the molecules into the channel, they bind themselves with the antibodies, gradually increasing the obstruction of the channel. It follows that the impedance of the channel increases with time. The final value attained by the impedance is depending on the amount of proteins that are in the sample under study. Quoting the Singh paper: “the pore conductivity decreases” (because the free dimension of the hole, i.e. the value d of FIG. 13, decreases as the amount of proteins increases, which bind themselves on the internal walls of the channel) “as the peanut protein concentration increases, since the effective pore diameter is reduced upon binding of peanut protein to its surface immobilized antibody”. Hence, the device is used for estimating the concentration of proteins in the sample under study. A typical measure lasts around an hour (the time needed for the molecules to diffuse and bind), as given in the graphs of the paper, two of them being represented in FIGS. 14 and 15. The authors increase the concentration of the proteins and observe the increase of the impedance; for each concentration they have to wait at least 50 minutes so that the signal balances itself out attaining a certain maximum value.

The molecules diffuse slowly into the channel for a long time, and the measurement is not immediate, it is rather given by the final result of an hour of interaction between the studied sample and the device. As a consequence, it does not deal with a device analyzing the single molecules, rather an tool that gives <<macroscopical>> information on the studied biological sample, as obtained as overall average effect of all the molecules interacting with the membrane.

FIG. 15, in particular, illustrates the results obtained with nanopores not larger than 15 nm. In this case, the impedance rises abruptly already with the first tested concentration, the lowest one, then it saturates and the device becomes <<blind>> because it does not detect concentration increases in the sample any longer, due to the fact that the functionalized channel is saturated by the molecules and does not varies its impedance any longer. This however doe not mean that there is a single-molecule analysis, since the measurement in any case is made on the whole membrane, but only that the device is readily saturated.

In the light of the foregoing, there is clearly the need of having at disposal new methods and means of detection of molecules, which are able to overcomes the drawbacks of the prior art.

Former studies of the Inventors [17] have already led to the realization of nanopores wherein the diameter of the fabricated hole with the FIB (Focused Ion Beam) has been reduced by bio-functionalization with DNA molecules up to a dimension compatible with the single-molecule analysis. This process allows to obtain, by a single step of preparation, both the resizing of the hole and its chemical activation needed to make it selective to the interaction between the specific probe molecules adherent to the hole surface and the target molecules submerged in the solution.

The fundamental elements of the measurement apparatus are a cell constituted by two reservoirs containing a ionic solution (typically KCl 1 molar buffered at pH 8 with HEPES 10 mM), communicating only through the nanopore, and two electrodes (wires of silver chloride, Ag/AgCl) for the application of a voltage and the detection of the current.

The cell is positioned on an anti-vibration table within a double Faraday cage so as to reduce the mechanical noise as well as the electrical one. The current is detected by a traditional Patch-Clamping electronics (Axopatch 200B, Axon Instruments).

The chips are constituted by a Silicon substrate whereon a thin film of silicon oxide and a variable-thickness film of silicon nitride are successively deposed (FIG. 2). By a chemical etching process, the chip is hollowed out from below, so as to expose the suspended silicon nitride membrane, obtaining a window having width equal to around 80×80 μm. On the upper portion of the chip, it is possible, but not necessary, to realize metallic arrangements functioning as local electrodes (FIG. 2).

The chips are nano-bored by using a Ultra High Resolution Field Emission Scanning Electron Microscope (UHR-FE-SEM) with Focused Ion Beam (FIB) which allow to produce, by ionic sputtering, nanopores of diameter comprised in the range of 30 nm to 50 nm.

FIG. 3 represents schematically an example of use of the device: holes functionalized with probe molecules of single strand, known sequence DNA can be utilized for the analysis of unknown single-filament molecules, identifying those molecules complementary to the probe molecules thanks to the fact that their passage through the hole is slowed down by transient hybridization processes.

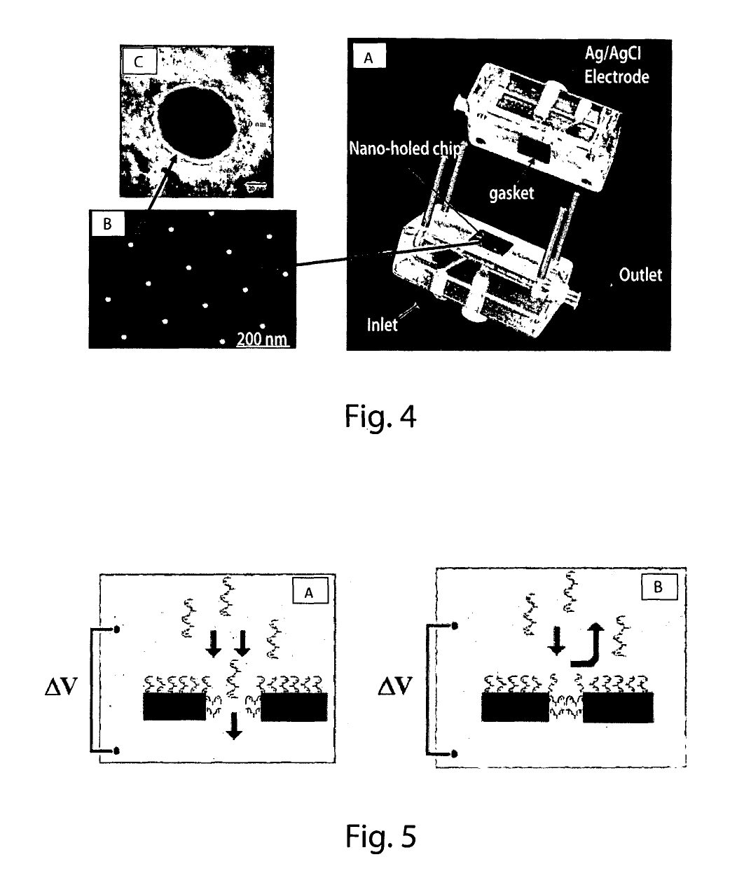

The device is illustrated in FIG. 4: a cell realized in Plexiglas (A) and equipped with a microfluidics system houses the chip containing an array of holes (B) chemically functionalized (C) for the selective analysis of single molecules.

However, the method above described does not solve the problem of the low frequency of the detectable events.

It is specific subject-matter of the present invention a device for the detection of single predefined target molecules in a ionic solution, the device comprising:
a substrate, suitable to be put in contact with the ionic solution, which comprises at least one or more nanopores functionalized with probe molecules able to interact with said target molecules,
a voltage generator, for the generation of a predefined activation voltage across said substrate, which is suitable to favor the interaction of the target molecules with said one or more functionalized nanopores;
a first and a second electrode for the application of said predefined activation voltage across said substrate and therefore across said one or more nanopores;
means for the measurement of ionic current across said one or more nanopores;
   And being characterised in that each of said one or more functionalized nanopores:
is associated to two respective addressing electrodes for the measurement of said ionic current through the considered nanopore, which are part of said means for the measurement of ionic current;
is functionalized by a respective network;

said network has a mesh density such to hinder the translocation of the target molecule into the functionalized nanopore, allowing exclusively the passage of the ions present in the solution;

said a respective network comprising probe molecules that are able to interact with said predefined target molecules, in such a way that variations of the detected ionic current highlight the collision interaction of the target molecules with said one or more functionalized nanopores.

With “chemical networking” it is here meant the creation of chemical bonds in three dimensions of the space. The chemical networking of the e.g. silane molecules, to which probe molecules are tied, creates a partial covering of the nanopore opening. The degree of covering depends on the degree of networking, i.e. the spatial density of the molecules constituting the network.

The skilled person can determine each time semi-empirically which average density is required and prepare a network such that it hinders the translocation of the target molecules in the nanopore. For example, the passage of the molecules of single-strand DNA is hindered by a network wherein the average distance between probe molecules is less than 1 nm.

It is also possible, by means of local functionalization techniques, to functionalize two different nanopores for the analysis of different target molecules, with the same device according to the invention. These local techniques however do not have shown to be effective as yet.

The functionalization of the nanopore normally involves the whole surface of the nanopore, and this is an advantage, because one does not have to utilize local functionalization techniques which are still not effective. However, in the future one will be able to think about functionalizing only an opening of the nanopore (that in contact with the solution comprising target molecules) falling within the same technical concept of the invention, i.e. impeding the translocation to the end of detecting the molecules by collision.

The electrodes associated to the nanopore, in the case of a substrate with a plurality of nanopores, are electrodes which measure the current locally.

Preferably according to the invention:
said one or more functionalized nanopores are made within a solid-state planar structure;
said one or more nanopores have, thanks to said network, an effective diameter lower or equal to the minimum dimensions of said predefined target molecule, calculated as:

d_{eff}=2(1/Rσπ)^{1/2}
Wherein R is the electrical resistance of the functionalized nanopore, σ the conductivity of the ionic solution, l the thickness of said planar structure.

Preferably according to the invention, said planar structure is formed by a first layer of semiconductor material and a second layer in isolating material that includes the nanopores.

Preferably according to the invention, said semiconductor material is Silicon and said isolating material is Silicon nitride or Silicon oxide.

Preferably according to the invention:
said planar structure is interposed between a first and a second reservoir comprising respectively said first and second electrode,
the first and second reservoir containing a basic ionic solution which is in contact with the substrate,
the first reservoir further comprising the sample of molecules to be analyzed for the detection of said target molecules, and therefore said ionic solution with target molecules,
said first and second electrode being disposed to apply a voltage difference on two sides of said substrate which face respectively said first and second reservoir.

Preferably according to the invention, in the case of an only nanopore on the substrate, said two addressing electrodes coincide or are in contact with said first and second electrode.

Preferably according to the invention, the network is realized by silanization.

The activation of the silanized network can be effected by cross-linking agents with variable length having an end reactive to the amino group of the silane and the other end with a suitable group reactive for the probe molecule subjected to functionalization. Finally, the probe molecule of interest is made react with the cross-linking agent by suitable (natural or chemically inserted) reactive groups of the same molecule.

The silanization can be carried out at ambient temperature for a time larger or equal to 2 min, indeed below this reaction time one observes very hardly deformation of a network. The total time of reaction needed to obtain the desired effective diameter, instead, increases with the initial diameter of the hole and depends on the measurement of the effective diameter to be attained.

Another way to functionalize the nanopore can be the position of a layer of gold or similar metals to restrict the hole to a functional diameter. The activation of the gold network can be carried out by means of cross-linking agents of different lengths having sulphydryl groups on one hand and a suitable reactive group for the probe molecule on the other hand, and subsequent reaction with the probe molecule.

Preferably according to the invention, said predefined threshold voltage depends on the target molecule to be detected, its charge status, its dimensions, the temperature, and on concentration and pH of the utilized ionic solution.

Preferably according to the invention, the probe molecules and the target molecules are chosen in the group consisting of: oligo-nucleotides, dsDNA, LNA, PNA, RNAs, proteins, antibodies.
It is further specific subject-matter of the present invention a method for the detection of single target molecules in a ionic solution, the method comprising the use of a device according to the invention, and the execution of the following steps:
A. immersing said substrate in the ionic solution;
B. applying a pre-defined threshold voltage across each of said one or more nanopores, by means of said first and second electrode;
C. measuring the ionic current passing across each of said one or more nanopores, by means of said two respective addressing electrodes;
D. correlating possible variations of said ionic current measured in step C with at least an interaction between at least a target molecule and at least a respective nanopore among said one or more functionalized nanopores.

The correlation of the ionic current variation to collision events can be realized with different analysis tools and interpretation approaches, depending on the sought target molecule as well. In the case, for example, of DNA target molecules, the collision produces generally a transient reduction of the current that has a very short duration and depends on the affinity degree between target and probe molecule, the reduction being caused mainly by steric effects and ionic exclusion phenomena. In case the target molecules are proteins, it has been instead verified that the collision phenomena can lead to a temporary increase of the ionic current because of the larger charge carried by the same protein. Analogously, the collision processes associated with the presence of the target molecule of large dimensions (such as DNA strands over 1000 kb) can be associated to a variability of effects on the ionic current, which is larger than those corresponding to molecule of small dimensions (and hence more rigid), because of the larger conformation variability that the target molecules can assume during the approaching and interaction with the functionalized hole.

Preferably according to the invention, said predefined threshold voltage depends on the target molecule to be detected, its charge status, its dimensions, the temperature, and on concentration and pH of the utilized ionic solution.

Preferably according to the invention, the probe and target molecules are chosen in the group consisting in oligo-nucleotides, dsDNA, LNA, PNA, RNAs, proteins, antibodies.

The present invention will be now described by way of illustration but not by way of limitation, according to its preferred embodiments, with specific reference to the figures of the enclosed drawings, wherein:

FIG. 1 shows the functioning principle “Coulter Counter” of the nanopores for the single-molecule analysis. On the left, it is schematically represented the nanometric hole immersed in the ionic solution. Once applied a voltage difference ΔV, the molecules immersed in the solution, which are negatively charged, tend to pass through the hole, provoking a transient reduction of the ionic current (on the right).

FIG. 2 shows a schematic representation of the starting chip of Si/SiN.

FIG. 3 shows the holes downsized by chemical functionalization for the selective sensing of single target molecules.

FIG. 4 shows the NPA device based on an array of bio-functionalized holes for the selective single-molecule analysis. A:

Measurement cell realized in Plexiglas containing the central housing for the chip of Si/SiN, the microfluidics system, two reservoirs for the ionic solution and a pair of electrodes Ag/AgCl for applying the voltage and measuring the current. B: Surface of 80×80 μm² of the chip having thickness 20 nm and containing the array of holes fabricated at the FIB with starting dimensions between 30 and 50 nm. C: A single hole downsized and activated by chemical bio-functionalization for the selective recognition of the target molecules dispersed in the reservoirs.

FIG. 5: Case A, Translocation, the functionalization reduces the dimensions of the hole without closing it, the target molecules go through the channel causing a transient current reduction whose duration is a function of the dimensions of the molecules under analysis and the interaction between the latter and the probe molecules bound to the channel surface. Case B, Collision, the network of probe molecules allows the detection of a monitoring current but not the passage of the target molecules, which are instead forced back by the functionalized surface upon which they bounce, colliding with a dynamics that is function of the interaction with the probe molecules.

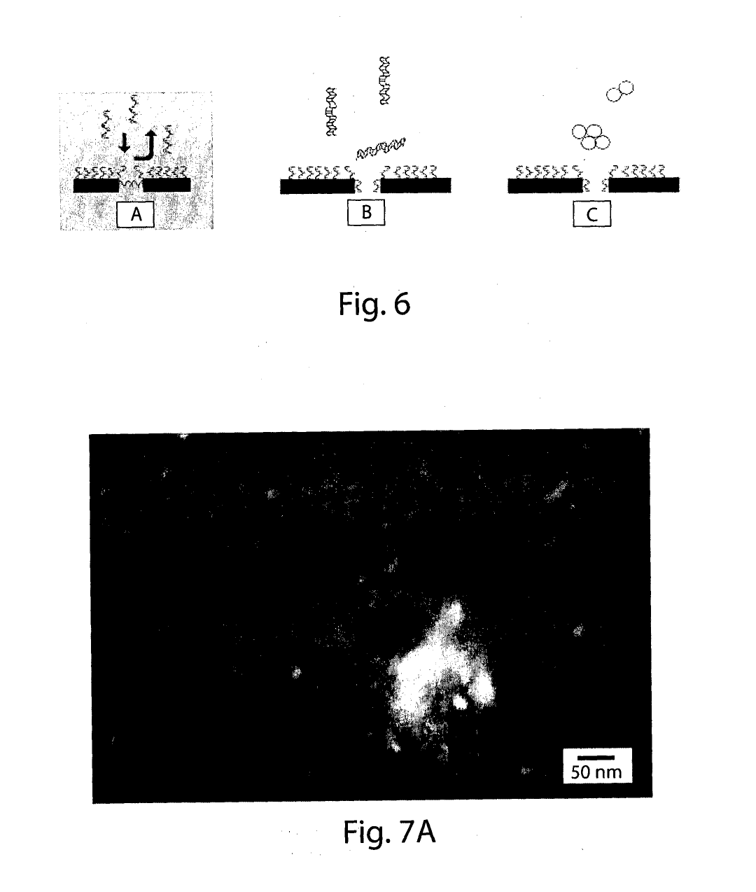

FIG. 6 shows collision events that can generate a transient increase of current. A: the hole functionalized with a probe molecules network according o the invention; B: collision of the hole with a molecule having a conformation not suited to translocation; C: collision of the hole with a molecule larger than the channel.

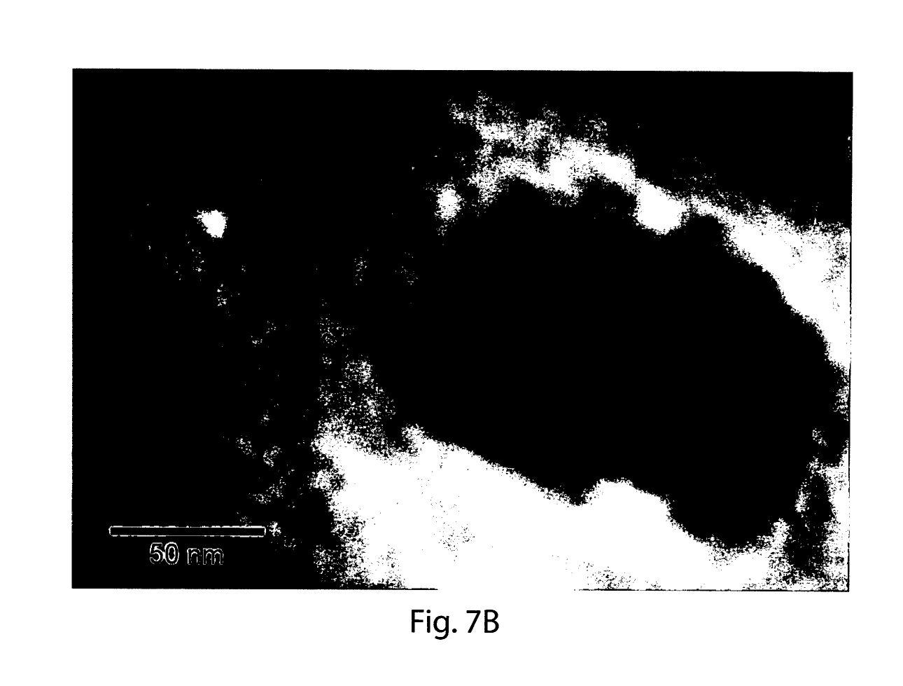

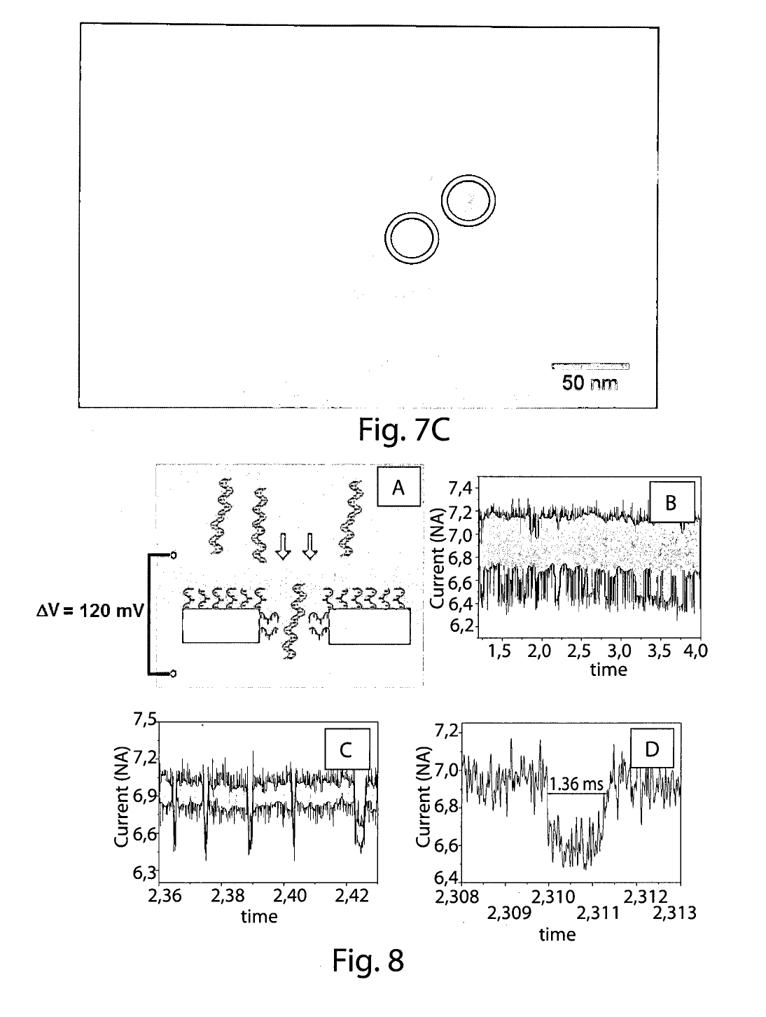

FIG. 7 shows: 7A. SEM image of the Silicon nitride surface of a chip comprising a hole fabricated by FIB and functionalized with a probe molecules network according to the invention. The molecules for functionalization (oligo-nucleotides 45-mer) are distributed on the whole surface and visible as light aggregates and clusters. 7B. Image of a hole fabricated by FIB and functionalized with RMP. The functionalization molecules (oligo-nucleotides 45-mer) form a network within the hole. In some points they are visible as circular structures. 7C. SEM image of a hole fabricated by FIB and functionalized with the probe molecules network. The network of probe molecules contains larger meshes (darker passing zones indicated by circles).

FIG. 8 shows: 8A. Layout of the translocation experiment according to the prior art during which ADNA molecules go through electroforetically a channel bio-functionalized with probe molecules 45mer; 8B: Current plot detected during the experiment; 8C, 8D: progressive magnifications of the plot to visualize the single blockade events corresponding to the passage of the molecules into through the channel.

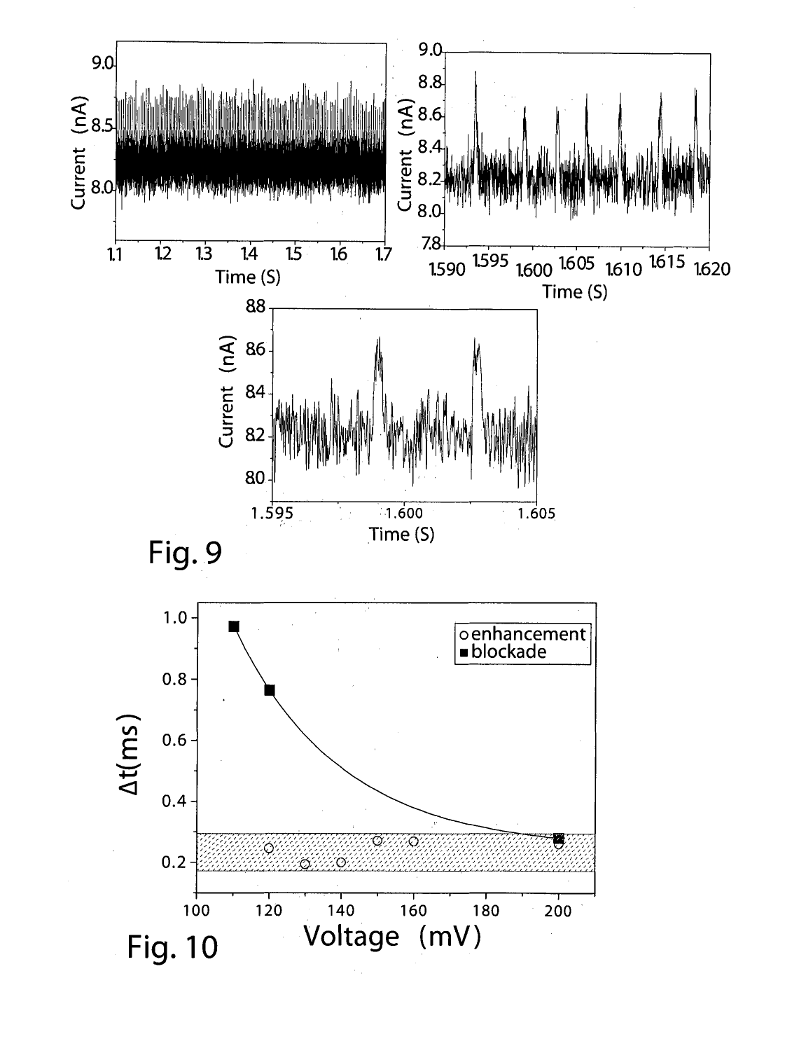

FIG. 9 shows the current plots with enhancement, as recorded during experiments of collision between a hole functionalized with RMP and ADNA molecules, according to the invention.

FIG. 10 shows a synthesis graph of the average values of duration of events, that have been recorded at different voltages in the case of translocations, with transient decreasing of the current (blockades, filled squares), according to the prior art, and the collisions with transient increase of the current (enhancement, blank circles), according to the invention.

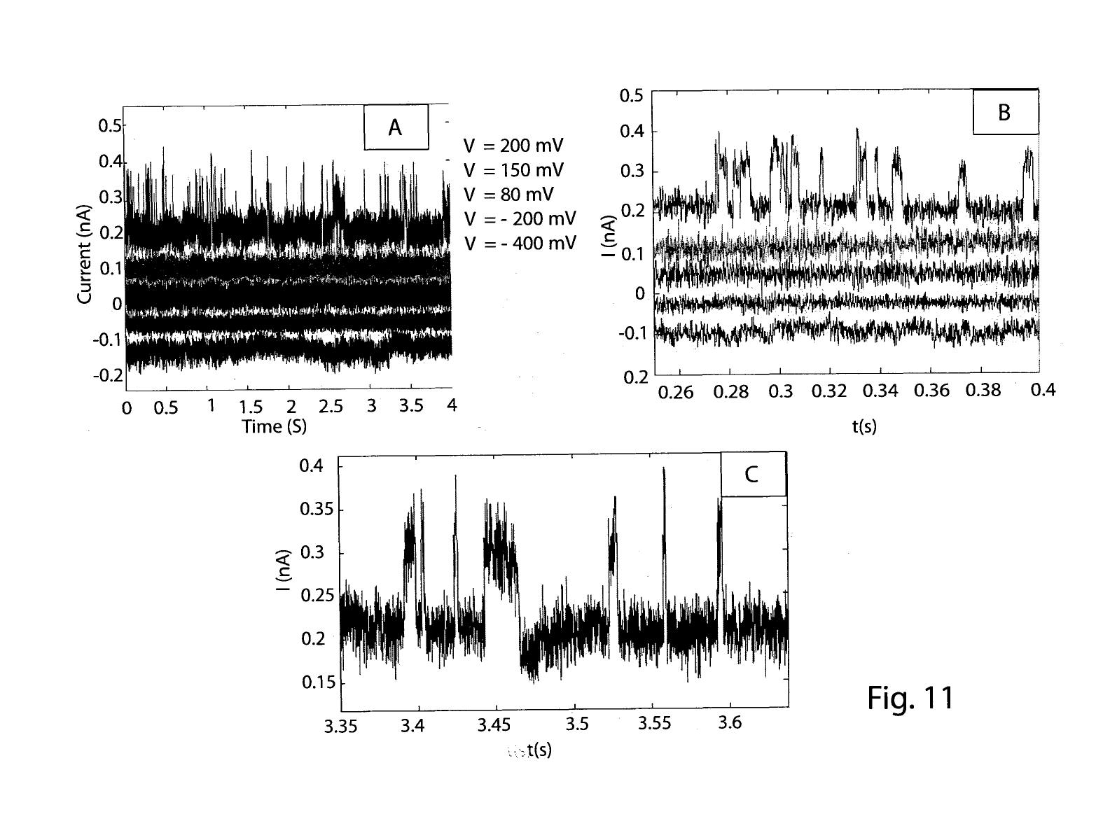

FIG. 11 shows the current plots as obtained during the experiments of collision between target proteins and a hole functionalized with probe molecules having a specific interaction with the proteins, according to the invention. Image B represents a magnification of image A. The colors of the plots are indicative of the voltage used during the experiments, as in the label. Image C represents a further magnification of the plot of figure B corresponding to a voltage of 200 mV.

FIG. 12 shows in (A) a commercial filter produced according the above-mentioned article of Singh, which has a thickness of no less than 6 micron (Singh, pages 101, statement placed under formula no. 7) which contains many holes produced by irradiation with high-energy ions; figures (B) and (C) gives two successive magnifications of a membrane set up in a similar way and cut to show the surface filled with holes, and the below through channels, whilst figure (D) is an image of the surface.

FIG. 13 shows a diagrammatic representation of the interaction of the device of Singh with the target proteins (blue) during an electrophoresis experiment (a voltage difference is applied between the two sides of the membrane).

FIG. 14 shows data given in the paper of Singh for the device containing channels of diameter equal to 50 nm; with the increase of the proteins concentration in the sample under study, the impedance of the device rises because more than one protein bind themselves to the internal surface of the functionalized channels.

FIG. 15 shows data given in the paper of Singh for the device containing the channels of diameter equal to 15 nm. With the increase of the proteins concentration in the sample under study, the impedance of the device rises initially, then it saturates.

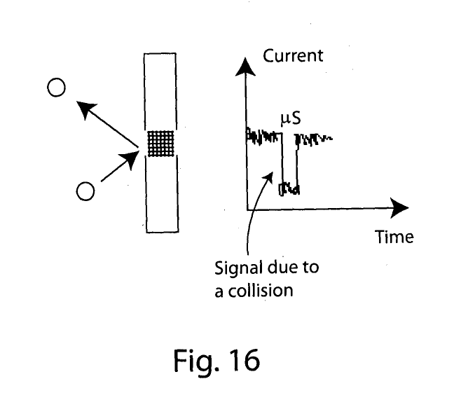

FIG. 16 shows a principle functioning diagram of the nanopore device according to the invention, based on the collision between the target molecules and the device functionalized with a probe molecules network.

The inventors have now developed a molecules detection method based on collision events between the target molecules under study and an array of holes which are almost completely closed thanks to the functionalization with probe molecules. The closure of the holes occurs with the formation, at the entrance of the hole, of a kind of “probe molecules network” (RMP) which allows the recording of a monitoring detectable current (IM) due to the passage of the charged ions of the solution, but hinders the translocation of the target molecules. In other words, the nano-holed membrane constitutes a [symbol] chemically active network [symbol] on which the target molecules collide, which are attracted by the electrical field, causing a variation of the monitoring current variation. The duration and the amount of collision events provide a qualitative and quantitative information on the process of interaction between probe and target, and therefore on the amount and type of molecules that are in the sample under study. Hence, the process of preparation of the molecular network comes out to be independent from the dimensions of the studied molecules, so that the device may be utilized even for the analysis of complex proteins. Therefore, according to the present invention, within the above-described device, a chip is used which contains an array of holes that are functionalized in such a way to generate a “probe molecules network” (RMP) for the analysis of target molecules by collision processes. The difference between the two approaches based on, respectively, translocation and collision processes, is described diagrammatically in FIG. 5: in the first case, A, the functionalization reduces the size of the hole without closing it, the target molecules cross the channel causing a transient current reduction, whose duration is a function of the analyzed molecule dimensions and the interaction between the latter with probe molecules bound to the channel surface. In the second case, B, the RMP allows the detection of a monitoring current but not the passage of the target molecules, which are instead forced back by the functionalized surface whereon they bounce, collide with a dynamics that is a function of the interaction with the probe molecules. In the latter case, the device functions regardless of the dimensions of the target molecules, providing however an immediate information on the specificity and the duration of the interaction with the probe molecules. The exact form of the signal associated with the occurred interaction can instead be of various types. Some experiments already realized in the laboratory show that the RMP can react dynamically to the collision giving rise, in some cases, to a current increase, i.e. an upwards spike, rather than to its reduction (concerning dimensions), i.e. a blockade (see below). The upwards spikes are associated to fluctuations of the molecules composing the RMP, which are indeed, in turn, partially forced back during the collisions, remaining however bound to the channel's wall. This generates variations of the “effective diameter” of the holes, meant as an electric parameter rather than a geometrical parameter: during the collision, the displacement of the probe molecules allows a temporary increase of the channel conductance and therefore of the detected current.

To make the concept clearer, FIG. 6 shows two possible collision events capable of generating current increases caused by the temporary displacement of the molecules of the RMP with respect to their initial position. The image A represents the initial situation with the hole closed by the RMP. The image B illustrates the interaction of the hole with a DNA molecule having a shape not suited for the translocation: The molecules of the RMP move with respect to the initial position giving an effect of “partial re-opening” of the hole, however not sufficient to the passage of the molecule. Image C shows the collision of the hole with a molecule (for example a protein) with dimensions larger than the effective diameter of the channel. Even in this case, the partial re-opening as induced by the movement of the RMP (and the additional charge carried by the probe molecules) does not allow the passage, whilst it generates upwards spikes in the current plot.

Hence, the interaction between probe molecule and target molecule can have as an effect both a partial additional hole occlusion associated to the permanency of the target molecule at the entrance of the channel, with a consequent reduction of the current, and a displacement of the probe molecules, with an increase of ions flux. In both cases, the problem of the detection is shifted from the usual one of studying the details of the rapid dynamics of the translocations, to the one of analyzing the effective transient re-dimensioning of the channel itself during the interaction. Therefore, the measurement becomes substantially independent from the actual dimensions and target molecules conformation (folded status), capture ability and ability to go through the hole.

One can therefore affirm that the present invention transforms a potential problem into a resource: the collisions are more frequent than the translocations in the nanopore devices, their analysis does not require a specific dimensional adjustment of the holes and can be applied to complex molecules as well. At the same time, the device according to the invention keeps the advantages associated to the nanopore measurements with respect to the traditional μ-array: it needs not the labeling of the target molecules, it substitutes the electric reading to the optical one (this means an increase of the measurement speed and the reduction of the apparatus costs) and allows parallel analyses.

As specified in the previous points, the present invention allows to develop devices for the bio-sensors based on nanopores, solving some of the problems generally encountered in this field. Some of these problems relate to the fabrication of the device: the process of functionalization by RMP network here proposed is of simple application, it allows to reduce the number of steps needed for the production of functionalized holes and to make the fabrication of the device independent from the dimensional constraints imposed by the specific final application. In particular, the following advantages are stressed:

the use of the functionalization to reduce a posteriori the dimension of the holes up to a dimension compatible with single-molecule detection allows to utilize standard lithographic techniques for the fabrication of the starting holes, thus reducing very much the cost of the device with respect to the case in which fabrication techniques are utilized such as FIB, TEM, ionic sputtering, epitaxial re-deposition of re-closing isolating material;

the functionalization process by formation of the RMP network is extremely simple, fast, and does not need an excessive control of the chemical-physical parameters, it can be carried out using various types of probe molecules (depending on the final application);

the analysis of the collision or processes rather than analysis of the translocation processes reduces the problems concerning the dimensional calibration and is applicable also to the complex and large molecules such as proteins. The collisions are moreover more frequent and occur even in the absence of unfolding processes of the target molecules (i.e. independently from their conformation);

the device keeps its advantages associated with the nanopore measurements with respect to the traditional μ-Array: it does not need labelling of the target molecules, substitutes the electric reading to the optical one (that means an increase of the measurement speed and a reduction of the apparatus costs) and allows parallel analyses;

in the case the collision events are associated to an increase rather than to a reduction of the current, what can occur only in the presence of a RMP network behaving in a dynamic manner, their recognition with respect to the hole accidental occlusion is extremely simple, thus reducing the impact of the “false positive”;

the collision events have a dynamics practically independent from the applied voltage: by increasing the voltage, the frequency and, slightly, the amplitude of the events increase, but not their duration, which depends mainly on the probe-target interaction. This allows to utilize higher voltages to reduce the overall duration of the measurement process (thanks to the increase of the events occurrence rate) without making the requirements concerning speed and noise of the electric current measurement apparatus excessively strict (and costly).

### EXAMPLE 1

### Preparation of Functionalized Nanopores According to the Invention and Analysis of Target Molecules Collision Events

This study has been carried out with a prototype device realized in the Nanomed laboratories and concerns:
the demonstration of the possibility to realize and functionalize nanopores;
the detection of translocation events without interaction across functionalized holes according to the prior art [17];
detection of collision events between DNA target molecules and single holes with RMP in conditions of no specific interaction;
the detection of collision events between target proteins and single holes with RMP in conditions of specific interaction.

### Preparation of Functionalized Holes in Such a Way to Allow the Translocation of the Target Molecule

Nanopores have been realized which have a diameter of around 30 nm within silicon nitride membranes having thickness of 20 nm using a focused ion beam. Subsequently, the nanopores have been functionalized with oligo-nucleotides. The final nanopore has been observed by SEM imaging.

The process provides the following steps:

Pre-treating of the substrate: the substrate has been washed with ddH₂O; treated with amino-propyl-triethoxy-silane (20% solution of ddH₂O) 1 hour at ambient temperature;

Activation of the substrate: treatment with 1,4-phenylene-disothiocyanate (5% solution of dimethyl-sulphoxide) 5 hours at ambient temperature; washing with dimethyl-sulphoxide (2 times); washing with ddH₂O 100 nM; incubation at 37° C. 0/N into a humid container.

Deactivation of the Substrate

Washing of the surface with ammonia 28% (2 times, each of 30 min); washing of the surface ddH₂O (two times each of 15 min).

Preparation of the Holes Functionalized with RMP which does not Allow the Translocation of the Target Molecule

Nanopores have been realized, which have a diameter of around 25 nm, within a silicon nitride membrane having thickness of 20 nm with a focused ion beam. Subsequently, the nanopores have been functionalized with oligo-nucleotides. The final nanopore has been observed by SEM imaging.

The process provides the following steps:

Pre-treatment of the substrate: the substrate has been washed with ddH₂O and treated with amino-propyl-triethoxy-silane;

Activation of the substrate: treatment with 1,4-phenylene-diisothiocyanate (5% solution of dimethyl-sulphoxide) five hours at ambient temperature; washing with dimethyl-sulphoxide (two times); washing with ddH₂O (2 times); air-drying at ambient temperature;

Adhesion of DNA: manual deposition of oligo-nucleotide (45 mer) solution of ddH₂O 100 nM; incubation at 37° C. 0/N in a humid container.

Deactivation of the Substrate

Washing of the surface with ammonia 28% (2 times each of 30 min); washing of the surface ddH₂O (2 times each of 15 min).

The fundamental step of the process of preparation of the RMP is the first one. Indeed, exactly the silanes aggregate with each other (mainly in the liquid phase) till they form the network. In the case of liquid phase silanization, the aspect to be taken into consideration is the initial dimension of the hole: if the nanopore has a diameter of 30 nm, the network does not close completely the hole. In this case therefore, the detection via collision can take place only if the target molecules are larger than the effective post-functionalization diameter, otherwise there are simple translocations of molecules. Instead, if the initial diameter of the hole is smaller and 30 nm, the APTES closes completely the hole, allowing the detection via collision also for molecules having small dimensions (down to a minimum of 1 nm). In this case, the ionic current that one measures is tied to the passage of ions through the network: indeed, being constituted by molecules, it is not close-grained but one can imagine it just as a “tennis racket”. The liquid phase silanization allows to cover with a RMP even larger holes, simply varying the holes exposition time to the gaseous phase silanes molecules.

As for the probe molecule, the only requirement is that it had a final amino-group able to tie itself to the diisothiocyanate: it is not indispensable to use oligo-nucleotides, but one can functionalize the nanopore with dsDNA, LNA, proteins, antibodies, etc.

When the probe molecules, rather than distributing on the edge of the hole, form a network on the whole area of the hole, one obtains a RMP, as in the case of the holes shown in FIG. 7 A, B, C.

The RMP is constituted when the initial diameter of the hole fabricated at FIB is reduced by functionalization till an electric effective diameter is obtained which is smaller than the dimensions of the target molecules. To obtain such a condition, it is possible to act on:

initial dimensions of the hole;

the dimension of the probe molecules;

the thickness of the chemical activation layer which ties the probe molecules to the substrate. This can be done by acting for example on the initial process of silanization of the substrate. The silanes are molecules which create networks naturally, whose extension depends on the specific procedure utilised for the treatment of the surface (silanization in liquid or vapour phase), the duration of the treatment and the utilised concentrations. By playing with these parameters, it is possible to obtain larger ordered or aggregated monolayers. In the second case, the obtained functionalization is less uniform but more efficient in the building of the networks on the holes. The RMP networks that are visible in the previous images have been obtained by overnight silanization in the liquid phase and at high concentration.

Translocation Events without Interaction Across Functionalized Holes in such a Way to Allow the Translocation

The functionalized nano-holed chip has been inserted in the micro-fluidic cell (filled with a solution of KCl 1 M) to measure its electric resistance variation due to the presence of DNA on the walls of the channel, obtaining a final effective diameter equal to around 5 nm. Within the reservoir wherein the negative electrode was, it has been inserted the a solution containing ADNA (0.17 nM) diluted in KCl 2M. In the other reservoir, the KCl solution of 0.01M has been inserted. Constant voltage measurements have been effected during around 160 seconds at 120 mV, low-pass Bessel filter at 5 kHz and sampling rate SR of 250 kHz.

In FIG. 8, the results obtained during the translocation of Λ-DNA (around 48 kbp) through a hole functionalized with single-strand DNA molecules (GAPDH gene, 45mer) are shown, according to the prior art. By applying a voltage of 120 mV between the reservoirs, the target molecules are pushed to go through the channel, and each passage event is detected as a transient current reduction whose duration is a function of the target molecules length, their conformation during the passage and the applied voltage.

Collision Events without Interaction with Holes with RMP

The nano-holed chip functionalized according to the invention has been inserted in the micro-fluidic cell (field with a solution of KCl 1M) to measure its electric resistance variation due to the presence of DNA on the walls of the channel, obtaining a final effective diameter equal to around 2 nm. Within the reservoir wherein the negative electrodes was, it has been inserted the a solution containing ADNA (0.17 nM) diluted in KCl 2M. In the other reservoir the KCl solution of 0.01 M has been inserted. Constant voltage measurements have been affected during around 160 seconds at 400 mV, low-pass Bessel filter at 5 kHz and sampling rate SR of 200 kHz.

In FIG. 9, measurements are quoted which have been obtained by carrying out experiments of collision between LMBDA-DNA molecules and the surface of a chip containing a hole functionalized so as to obtain a “probe molecules network” (RMP) with oligo-nucleotides molecules, therefore in the absence of specific probe-target interaction.

The measurements show the presence, in the current plot, of signal enhancement events which are generated by the dynamic displacement of the probe molecules of the RMP caused by transient and non-specific collision with the target molecules.

The presence of events of transient increase of the electric current has been detected by other authors only in conditions of molecules translocations through low ionic concentration, non-functionalised holes. In such cases, the current enhancement is to be attributed to increase of the electric charge that is present within the channel during the passages of the charged molecules. It deals with a situation completely different from that of FIG. 9. In our case, indeed, the analysis of the obtained plots at different voltages shows that the duration of the current enhancement events is constant and independent from the electrophoretic speed of the molecules under examination, i.e. that the events represent collisions and not translocations. This results is shown in FIG. 10. The graph presents, together, the average events durations as recorded at different voltages in the case of translocations of FIG. 8 with decrease of the current (blockades, filled squares in the figure), and those of the collisions with an increase of the current of FIG. 9 (enhancements, empty circles in FIG. 10). The formers inversely depend on the voltage (the higher the voltage, the larger the speeds of going through, the smaller the duration of the event), the second ones are independent from the applied voltage).

Events of Collision with Interaction with Holes with RMP

For the realization of the experiment with proteins, a nanopore having an initial diameter equal to around 20 nm and thickness of the membrane equal to 20 nm has been used. Afterwards, the chip has been functionalized with ds-DNA by using the above described chemical activation process. The functionalised nano-holed chip has been inserted in the microfluidic cell, filled with a solution of DBA (usually utilised in electrophoretic mobility shift essay, EMSA): 20 nM HEPES-KOH pH 7.9, 0.1M KCl, 5% Glycerol, 0.2 mM EGTA, 1 mM DTT. The variation of the electric resistance due to the presence of DNA on the channel walls provides an estimation of the final effective diameter equal to around 3 nm. Within the reservoir wherein the negative electrode was present, a solution containing a nuclear extract of Hela cells stimulated with TNF-α containing also the protein of interest, NF-kB, has been inserted. Measurements at constant voltage during around 160 seconds at 200 mV, Bessel low-pass filter at two kHz and sampling rate SR of 200 kHz have been carried out.

The transcription factor Nf-kB is activated and can therefore interact with the probe, in this case a decoy-oligodeoxynucleotide (ODN) containing the restriction site sequence for NF-kB. The current plots in this case are quoted in FIG. 11 (the plots from below upwards have been obtained at different voltages: −400 mV, −200 mV, 80 mV, 150 mV, 200 mV). In particular, image B shows a magnification of image A wherein one can appreciate the occurrence of current enhancement events for applied voltages larger than 150 mV (which represents a threshold to be attained to generate collision events between the proteins dispersed in the solution and the RMP network on the hole). The threshold depends on the target under examination, in particular on its charge status, its dimension, its temperature, and on concentration and pH of the utilized ionic solution, which are the parameters that define the electrophoretic mobility of the molecules. The threshold is the voltage value under which no significant fluctuation of the current signal is detectable, because there is no interaction between probe network and target. Image C represents a further magnification of the plot corresponding to 200 mV wherein it is possible to appreciate the presence of current enhancement events of different duration. In the solution, indeed, proteins with different degrees of affinity and interaction with the probe molecules have been dispersed. The proteins which do not interact with the molecules undergo short collisions with the network (narrow upwards spikes), the proteins which interact with the probe molecules stay longer on the hole, generating a longer collisions (large upwards spikes).

A sample of proteins compatible with the probe molecules adherent to the surface of the hole produces therefore a periodic oscillation that is characteristic of the electric current between the two distinct states “open”-“close”, with a timing very different from that of a simple translocation. The specific interaction is associated to a transient current reduction during times longer than those of the simple translocation. For the proteins, see FIG. 11, one passes from hundreds of microseconds to the tens of milliseconds.

With respect to the above work of Singh, in order to construct a tool that is able to interact with the single target molecules, molecule by molecule, without that these penetrate into the channel and permanently tie to it, the invention proposes a device whose principle is diagrammatically represented in FIG. 16. Contrary to Singh et al., the invention does not analyze the averaged signal produced by the interaction of all the molecules of the sample with the device, rather, by using a fast and low noise electronics and a membrane containing an only hole (or containing a plurality of holes provided that they are individually measurable, e.g. with local electrodes), it detects single current spikes as produced by the rebound of the target molecules on the network of molecules tied to the hole's surface (see FIG. 8).

The measurement allowed by the method and the device according to the invention is fastest, has a duration ranging from micro-to milliseconds, and is able to distinguish between transient current modulation signals which are due to the collision with the device of a molecule interacting with the probe molecules or not. In both cases, interaction and no interaction, each time, depending on the involved molecules, the duration of the spike can change, or its form, the direction (upwards or downwards, i.e. an increase or reduction of the current), or the frequency, the voltage threshold to be applied in order that the spikes appear, the threshold being tied to the repulsion phenomena between target molecules and those adhered at the entrance of the hole.

The important elements of the system according to the invention are:

1) The fact that the network of probe molecules tied at the entrance of the hole does not allow to translocate, i.e. it hinders the target molecules from passing from a side to the other one of the nano-holed membrane;

2) The fact that one collects the electric signal of an individual hole (even in the case of array device), so as to analyze the collisions with it of the single target molecules. In the Singh device, this is not possible because the signal is collected as summation of all those produced by the simultaneous interaction of all the molecules present with all the holes of the membrane (they are great many).

Surely, even with the device according to the invention, though structurally different from that of Singh, it can occur in that the target molecules arrive on the network of probe molecules and here stably interact blocking the entrance. In this case, the device according to the invention gives an on-off signal as well, i.e. either the “right” target molecule is there or it is not there, however afterwards the hole becomes blind and is not usable any longer. One wishes here to propose is a bio-analytic device that is more complex and sensitive than that of the prior art, and able to provide finer information on the target molecules, playing with the temporary bond phenomena (collisions) instead of the stable interaction ones, i.e. the above-mentioned collisions.

### BIBLIOGRAFIA

[1] Kasianowicz J J, Brandin E, Branton D and Deamer D W 1996 Proc. Natl Acad. Sci. USA 93 13770.
[2] Howorka S, Cheley S and Bayley H, 2001 Nat. Biotechnol. 19 636-639
[3] Movileanu L, Howorka S and Braha O, 2000 Nat. Biotechnol. 18 1091
[4] Siwy Z, Trofin L, Kohli P, Baker L A and Martin C R 2005 J. Am. Chem. Soc. 127 5000-5001.
[5] Nillson J, Lee J R I, Ratto T V, Letant S E 2006 Adv. Mater. 18 427-431.
[6] Iqbal S M, Akin D, Bashir R 2007 Nat. Nanotechnol. 2 243-248.
[7] Chen P, Mitsui T, Farmer D B, Golovchenko J, Gordon R G, Branton D 2004 Nano Lett. 4 1333-1337.
[8] Wanunu M and Meller A 2007 Nano Letters 7 1580.
[9] Vlassiouk I, Takmakov P, Smirnov S 2005 Langmuir 21 4776-4778.
[10] J. J. Kasianowicz, D. L. Burden, L. C. Han, S. Cheley and H. Bayley, 1999 Biophys. J. 76 837-845.
[11] M. Ali, V. Bayer, B. Schiedt, R. Neumann and A. Ensinger 2008 Nanotechnology 19 485711-485719.
[12] M. Wanunu et al., “Electrostatic focusing of unlabelled DNA into nanoscale pores using a salt gradient” Nature Nanotehnology, DOI: 10.1038/NNAN0.2009.379.
[13] Kasianowicz, J. J., E. Brandin, D. Branton, and D. W. Deamer. 1996. “Characterization of individual polynucleotide molecules using a membrane channel” Proc. Natl. Acad. Sci. USA 93:13770-13773.
[14] Claudia Avis Madampage, Olga Andrievskaia, Jeremy S. Lee 2010 Analytical Biochemistry 396 36-41.
[15] Radu I. Stefureac and Jeremy S. Lee, Small 4 No. 10 (2008) 1646-1650.
[16] Singh et al., “Nanopore immunosensor for peanut protein Ara h1”, Sensors and actuators B: Chemical, Elsevier, vol. 145 no. 1, 4 march 2010 pages 98-103.
[17] Mussi V, Fanzio P, Repetto L, Firpo G, Valbusa U, Scaruffi P, Stigliani S, Tonini 2008 Superlattices and Microstructures 46 59.

1) Device for the detection of single predefined target molecules in a ionic solution, the device comprising:
a substrate, suitable to be put in contact with the ionic solution, which comprises at least one or more nanopores functionalized with probe molecules able to interact with said target molecules,
a voltage generator, for the generation of a predefined activation voltage across said substrate, which is suitable to favor the interaction of the target molecules with said one or more functionalized nanopores;
a first and a second electrode for the application of said predefined activation voltage across said substrate and therefore across said one or more nanopores;
means for the measurement of ionic current across said one or more nanopores;
and being characterised in that each of said one or more functionalized nanopores:
is associated to two respective addressing electrodes for the measurement of said ionic current through the considered nanopore, which are part of said means for the measurement of ionic current;
is functionalized by a respective network;
said network has a mesh density such to hinder the translocation of the target molecule into the functionalized nanopore, allowing exclusively the passage of the ions present in the solution;
said a respective network comprising probe molecules that are able to interact with said predefined target molecules, in such a way that variations of the detected ionic current highlight the collision interaction of the target molecules with said one or more functionalized nanopores.

2) Device according to claim 1, characterised in that:
said one or more functionalized nanopores are made within a solid-state planar structure;
said one or more nanopores have, thanks to said network, an effective diameter lower or equal to the minimum dimensions of said predefined target molecule, calculated as:
d_{eff}=2(1/Rσπ)^{1/2}
Wherein R is the electrical resistance of the functionalized nanopore, σ the conductivity of the ionic solution, l the thickness of said planar structure.

3) Device according to claim 2, characterised in that said planar structure is formed by a first layer of semiconductor material and a second layer in isolating material that includes the nanopores.

4) Device according to claim 3, characterised in that said semiconductor material is Silicon and said isolating material is Silicon nitride or Silicon oxide.

5) Device according to any claim 2 to 4, wherein:
said planar structure is interposed between a first and a second reservoir comprising respectively said first and second electrode,
the first and second reservoir containing a basic ionic solution which is in contact with the substrate,
the first reservoir further comprising the sample of molecules to be analyzed for the detection of said target molecules, and therefore said ionic solution with target molecules,
said first and second electrode being disposed to apply a voltage difference on two sides of said substrate which face respectively said first and second reservoir.

6) Device according to any claim 1 to 5, characterized in that, in the case of an only nanopore on the substrate, said two addressing electrodes coincide or are in contact with said first and second electrode.

7) Device according to any claim 1 to 5, wherein the network is realized by silanization.

8) Device according to any claim 1 to 7, wherein said predefined threshold voltage depends on the target molecule to be detected, its charge status, its dimensions, the temperature, and on concentration and pH of the utilized ionic solution.

9) Device according to any claim 1 to 8, wherein the probe molecules and the target molecules are chosen in the group consisting of: oligo-nucleotides, dsDNA, LNA, PNA, RNAs, proteins, antibodies.

10) Method for the detection of single target molecules in a ionic solution, the method comprising the use of a device according to any of the claim 1 to 9, and the execution of the following steps:
A. immersing said substrate in the ionic solution;
B. applying a pre-defined threshold voltage across each of said one or more nanopores, by means of said first and second electrode;
C. measuring the ionic current passing across each of said one or more nanopores, by means of said two respective addressing electrodes;
D. correlating possible variations of said ionic current measured in step C with at least an interaction between at least a target molecule and at least a respective nanopore among said one or more functionalized nanopores.

11) Method according to claim 10, wherein said predefined threshold voltage depends on the target molecule to be detected, its charge status, its dimensions, the temperature, and on concentration and pH of the utilized ionic solution.

12) Method according to claim 10 or 11, wherein the probe and target molecules are chosen in the group consisting in oligo-nucleotides, dsDNA, LNA, PNA, RNAs, proteins, antibodies.
